(19) United States
(12) Patent Application Publication
(10) Pub. No.: US 2011/0007156 A1
(43) Pub. Date: Jan. 13, 2011

(54) VIDEO BASED REMOTE OBJECT ACTIVATION/DEACTIVATION AND CONFIGURATION

(75) Inventors: Aviinaash Sankaranarayanan, Madurai (IN); Swaroop Shivaram, Bangalore (IN); Juluri Kumar, Bangalore (IN); Sankesh Hilot, Mumbai (IN); Bobby Narayanan, Bangalore (IN)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/499,979

(22) Filed: Jul. 9, 2009

(51) Int. Cl. H04N 7/18

(52) U.S. Cl. 348/143; 348/E07.085

(57) ABSTRACT

A system and method of monitoring a region and directly controlling objects in the region via a single interface are provided. The method includes displaying a video data stream on a viewing interface and controlling an object in a region via the viewing interface. The video data stream is associated with a data collection device monitoring the region, and the video data stream includes a representation of at least one object in the region that is displayed on the viewing interface.

### FIELD OF INVENTION

The present invention relates generally to video surveillance. More particularly, the present invention relates to monitoring a region and directly controlling objects in the region via a single interface.

### BACKGROUND

Video surveillance plays an integral and pivotal role in modern day security systems. In known security systems incorporating video surveillance, a user or operator can monitor a region remotely by watching video data streams from surveillance cameras located in the region. When a threatening situation develops, however, a remote operator monitoring the situation has no way of preventing the situation from escalating by, for example, opening or closing a door, switching lights on or off, switching a smoke detector on or off, or arming or disarming an intrusion panel.

For example, surveillance cameras can be placed in a shopping complex and focused on a cash register. Security personnel can remotely monitor the cash register by viewing video data streams from the cameras focused on the register. The video data streams can be viewed on a monitor or other viewing interface. However, if a theft occurs at the cash register, the security personnel have no way of preventing or stopping the theft via the viewing interface. For example, the security personnel cannot close the doors to and from the shopping complex via the viewing interface.

In known security systems, an operator or user must use separate modules or interfaces to monitor a region and control or configure objects in the region. For example, a security system can have a viewing module to view video data streams from cameras in a monitored region, a separate module to open or close a door in the region, and still a separate module to configure a control panel in the region. In known security systems, there is no single interface to perform all of the required tasks to effectively monitor and secure a region.

Multiple modules and interfaces increase the cost of a security system, necessitate a large amount of installation time, and make using the system difficult. Furthermore, when a user engages one module to perform a task such as securing a door or configuring a control panel, the user is not monitoring the region on the viewing module for a period of time. This makes the region even less secure during that period of time because the user cannot detect if another event occurs in the region that would require action.

Accordingly, there is a continuing, ongoing need for systems and methods of monitoring a region and directly controlling objects in the region via a single interface. Preferably, such systems and methods allow a user to continuously monitor a region while simultaneously controlling objects in the region.

### BRIEF DESCRIPTION OF THE DRAWINGS

FIG. 1 is a flow diagram of a method of configuring objects in a monitored region in accordance with the present invention;

FIG. 2 is a block diagram of a system for carrying out the method of FIG. 1 in accordance with the present invention; and

FIG. 3 is a block diagram of an installed system in accordance with the present invention.

### DESCRIPTION OF THE PREFERRED EMBODIMENTS

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments of the present invention include systems and methods of monitoring a region and directly controlling objects in the region via a single interface. Preferably, such systems and methods allow a user to continuously monitor a region while simultaneously controlling objects in the region.

In embodiments of the present invention, a user or operator can monitor a region on a viewing screen, monitor, or interface and can also control or configure objects visible on the same viewing screen, monitor, or interface. Accordingly, only one interface is needed to monitor a region and control or configure objects in that region. Controlling or configuring an object can be done quickly, efficiently, and easily because an operator or user need not engage multiple modules or interfaces to perform these tasks. No manual intervention is required to switch between viewing or monitoring, and controlling or configuring.

Further, security is enhanced and more reliable when systems and methods of the present invention are employed because a user can continuously monitor a viewing screen while controlling or configuring objects on the viewing screen. A user need not look away from the viewing screen to perform other tasks and can visually see objects while controlling or configuring those objects.

Controlling an object in the region is expedited when systems and methods of the present invention are employed. When a user views a video data stream on a viewing interface and detects a threatening condition or emergency situation, the user can immediately respond to the situation or condition by controlling an object in the region via the viewing interface. Controlling an object in the region via the viewing interface saves crucial time in emergency situations.

The configuration of some objects may not be instantaneous, but rather may take a period of time to execute. Systems and methods of the present invention provide for continuous video monitoring throughout the configuration of these objects. Even while the object is being configured, a user can continue to monitor the region in which the object is located as well as the status of the object's configuration.

In accordance with the present invention, video data streams are used as a direct tool or means to control, configure, or activate/deactivate objects that are viewed on a monitor, module, or interface displaying the video data streams. The objects can be controlled remotely by selecting or clicking on representations of the objects displayed on the viewing monitor.

In some embodiments of the present invention, controlling, configuring or activating/deactivating an object requires manual intervention by a user. In these embodiments, a user can remotely authenticate the manual control, configuration or activation/deactivation of the object via a monitor, module, or interface displaying a representation of the object.

In some regions, it may be desirable to alter security levels depending on for example, the population of the region, the time of day, or other varying conditions known by those of skill in the art. Systems and methods of the present invention allow a user to set and change security levels of a region based on a video data stream of the region presented to the user on a viewing screen. In some embodiments, the user can set or change the security level of the region via the viewing screen displaying the video data stream.

In some embodiments, systems and methods of the present invention present a user with an option to confirm or verify whether he is viewing real-time, pre-recorded, or simulated video data streams. For example, a user can select or click on a representation of an object on the viewing screen. Systems and methods of the present invention can provide an indication to the user whether the video displayed on the viewing screen is live, pre-recorded, or simulated. Based on the indication of the video's status, a user can take appropriate and necessary actions.

For example, in some embodiments, a user can select a flashlight visible on the viewing screen. If the video displayed on the viewing screen is live video, the flashlight on the viewing screen can flash a light to the operator, for example, to indicate that the operator is viewing a live video data stream.

Objects in a region that can be controlled include control panels, doors, windows, lights, smoke detectors, temperature controls, electrical systems, electrical appliances, or any other objects that would be known by those of skill in the art. In embodiments of the present invention, any object that is visible on a viewing interface can be controlled. In some embodiments, systems and methods of the present invention can be employed in connection building control and automation systems as known by those of skill in the art.

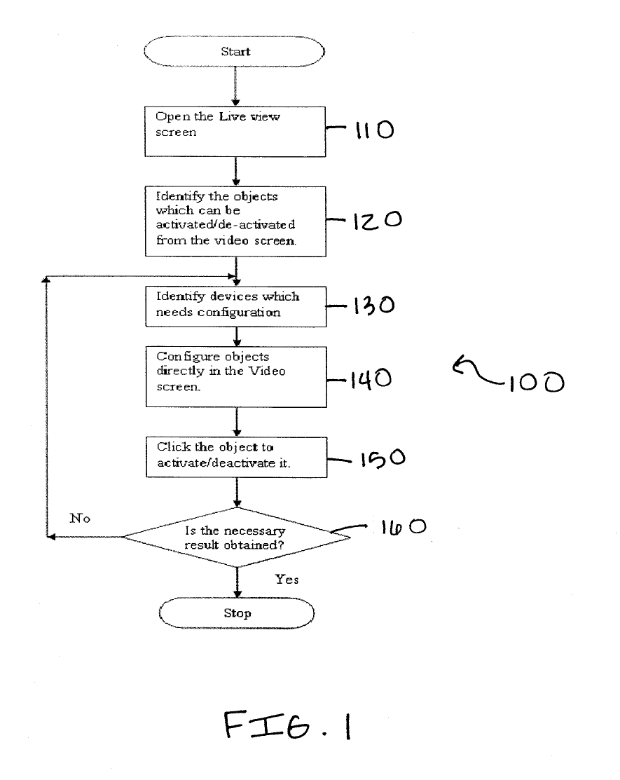

FIG. 1 is a flow diagram of a method 100 of configuring objects in a monitored region in accordance with the present invention. In the method 100, a viewing screen can display live video data streams from a surveillance camera in a region as in 110. Representations of objects in the region that can be controlled are identified on the viewing screen as in 120.

To configure an object in the region, a user or operator can select or identify a representation of the object on the viewing screen as in 130. Then the object in the region can be configured as in 140. Once the object is configured as in 140, a user can select or identify a representation of the object on the viewing screen to activate or deactivate the object in the region as in 150.

The method 100 can determine if the object in the region was properly controlled as in 160. If the object was properly controlled, the method 100 is completed. However, if the object was not properly controlled or more control of the object is desired, the method 100 can continue to allow a user to select a representation of the object on the viewing screen as in 130.

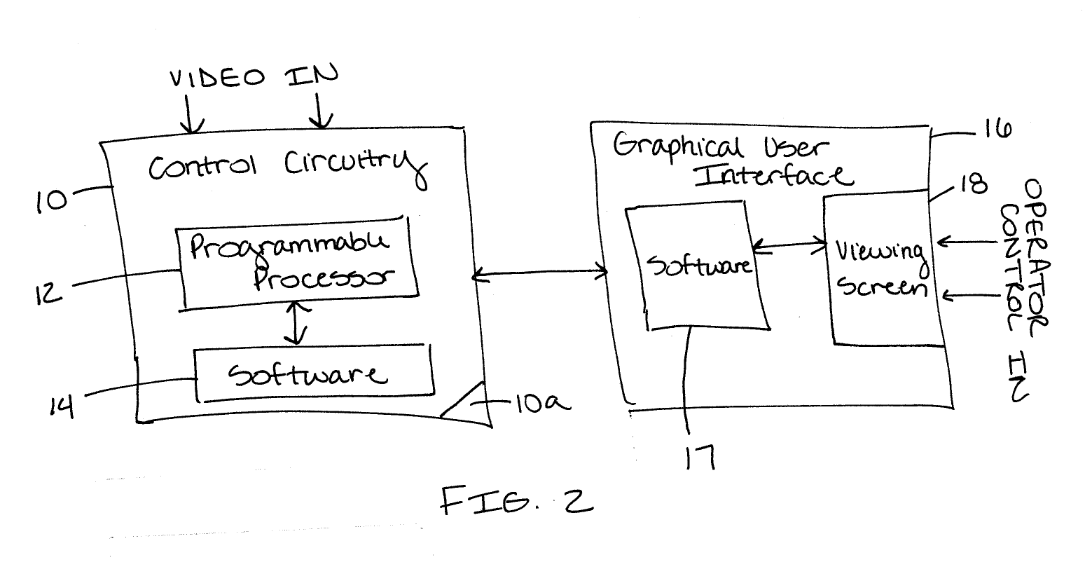

The method shown in FIG. 1 and others in accordance with the present invention can be implemented with a programmable processor and associated control circuitry. As seen in FIG. 2, control circuitry 10 can include a programmable processor and software 14, stored on a local computer readable medium, as would be understood by those of ordinary skill in the art. Video from a plurality of cameras, recorders, or other data collection or storage devices can be input into the programmable processor and associated control circuitry.

An associated user interface 16 can be in communication with the processor 12 and associated circuitry 10. A viewing screen 18 of the user interface, as would be known by those of ordinary skill in the art, can display the video input into the programmable processor 12 and control circuitry 10 in interactive viewing windows. In embodiments of the present invention, the user interface 16 can be a multi-dimensional graphical user interface.

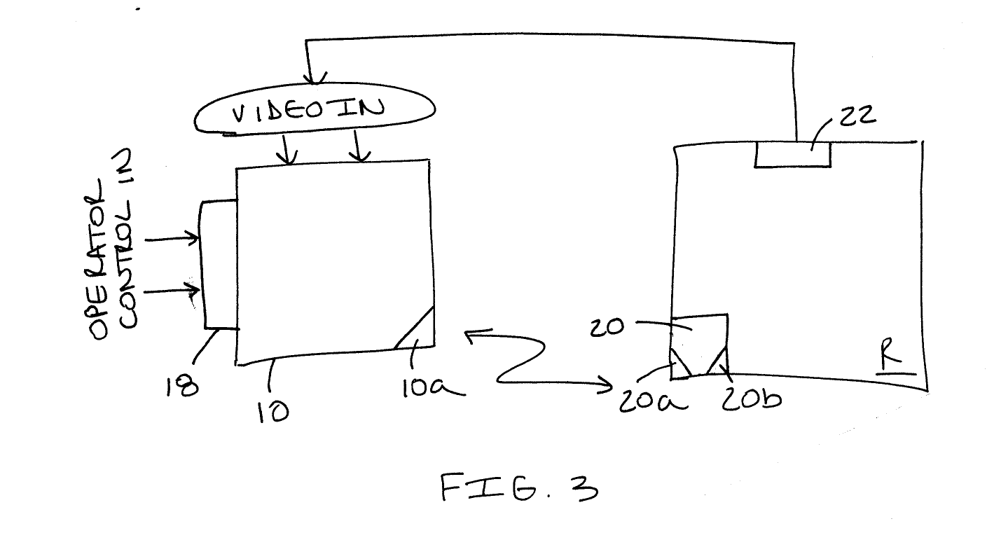

FIG. 3 is a block diagram of an installed system in accordance with the present invention. As seen in FIG. 3, at least one surveillance camera 22 can be installed in and monitor a region R, and at least one object 20 can be located in the region R. The object 20 can include a transceiver 20a and control circuitry 20b. Exemplary objects include control panels, doors, windows, lights, smoke detectors, temperature controls, electrical systems, electrical appliances, or any other objects that would be known by those of skill in the art.

In embodiments of the present invention, video data streams from the camera 22 can be input into control circuitry 10 and displayed on the associated viewing screen 18. A user at the viewing screen 18 can monitor the region R via the screen 18 displaying the video data streams from the camera 22.

The video displayed on the viewing screen 18 can include a representation of the object 20 in the region R being monitored. An operator or user can select the representation of the object 20 on the viewing screen 18 to control the object 20 in the region R. When the object 20 is selected on the viewing screen 18, the control circuitry 10, programmable processor 12, and associated software 14 can transmit a command to the object 20 in the region R.

The object 20 can be in wired or wireless communication with the control circuitry 10 as would be known by those of ordinary skill in the art. When remotely situated, the object 20 can wirelessly communicate with the control circuitry 10 via transceivers 10a and 20a.

When the object 20 receives a command from the control circuitry 10, the control circuitry 20b of the object 20 can cause the command to be executed by the object. In this manner, a user can monitor a region R and directly control an object 20 in the region R via a single interface 18.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

What is claimed is:

1. A method comprising:
displaying a video data stream on a viewing interface, the video data stream associated with a data collection device monitoring a region, and the video data stream including a representation of at least one object in the region displayed on the viewing interface;
controlling the object in the region via the viewing interface.

2. The method of claim 1 wherein controlling the object in the region further comprises configuring the object in the region via the viewing interface.

3. The method of claim 2 wherein controlling the object in the region further comprises authenticating the configuration of the object in the region.

4. The method of claim 1 wherein controlling the object in the region further comprises activating or deactivating the object in the region.

5. The method of claim 1 wherein controlling the object in the region further comprises selecting the representation of the object displayed on the viewing interface.

6. The method of claim 1 wherein displaying the video data stream occurs in real-time.

7. The method of claim 1 wherein the data collection device comprises a camera.

8. The method of claim 1 wherein the viewing interface comprises a visual display device.

9. A method comprising:
displaying a video data stream on a viewing interface, the video data stream associated with a data collection device monitoring a region; and
controlling a security level of the region via the viewing interface.

10. The method of claim 9 wherein displaying the video data stream occurs in real-time.

11. The method of claim 9 wherein the data collection device comprises a camera.

12. The method of claim 1 wherein the viewing interface comprises a visual display device.

13. An interactive apparatus comprising:
means for displaying a video data stream on a viewing interface, the video data stream associated with a data collection device monitoring a region, and the video data stream including at least one representation of an object in the region displayed on the viewing interface;
means for controlling the object in the region via the viewing interface.

14. The method of claim 13 wherein the means for controlling the object in the region further comprises means configuring the object in the region via the viewing interface.

15. The method of claim 14 wherein the means for controlling the object in the region further comprises means authenticating the configuration of the object in the region.

16. The method of claim 13 wherein the means controlling the object in the region further comprises means for activating or deactivating the object in the region.

17. The method of claim 13 wherein the means for controlling the object in the region further comprises means for selecting the representation of the object displayed on the viewing interface.

18. The method of claim 13 wherein the means for displaying the video data stream occurs in real-time.

19. The method of claim 13 wherein the data collection device comprises a camera.

20. The method of claim 13 wherein the viewing interface comprises a visual display device.
